(19) United States
(12) Patent Application Publication
(10) Pub. No.: US 2009/0092873 A1
(43) Pub. Date: Apr. 9, 2009

(54) Fuel cell stack

(76) Inventors: Sung-Won Jeong, Suwon-si (KR); Keun-Yong Lee, Suwon-si (KR); Young-Seung Na, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/219,217

(22) Filed: Jul. 17, 2008

(30) Foreign Application Priority Data
Oct. 4, 2007 (KR) 10-2007-0099961

(51) Int. Cl. H01M 8/10; H01M 8/02

(52) U.S. Cl. 429/27; 429/30

(57) ABSTRACT

There are provided a coupling structure of a fuel cell stack capable of precisely and rapidly assembling a stack by a predetermined height. The fuel cell stack includes a membrane electrode assembly for generating electricity, separators disposed on both sides of the membrane electrode assembly, first and second end plates disposed on both sides an accumulated body of the membrane electrode assembly and the separators, and a coupling device penetrating the first end plate, the membrane electrode assembly, and the separators, and fastened into a fixing hole of the second end plate. The coupling device includes a head, a body, a thread, and a step formed at an interface between the body and the thread such that a cross-sectional area of the body is greater than a cross-sectional area of the thread, and stops the fixing when the step contacts the second end plate.

### CLAIM OF PRIORITY

This application makes reference to, incorporates the same herein, and claims all benefits accruing under 35 U.S.C. §119 from an application for FUEL CELL STACK earlier filed in the Korean Intellectual Property Office on the 4th of Oct. 2007 and there duly assigned Serial No. 10-2007-0099961.

### BACKGROUND OF THE INVENTION

1. Field of the Invention

The present invention relates to a fuel cell, and more particularly, to a coupling structure of a fuel cell stack capable of precisely and rapidly assembling a stack by a predetermined height.

2. Description of the Related Art

A portable fuel cell refers to a small-sized power generating device useful for a house, a yacht, and a camp as well as a small-sized power source for a laptop computer and a portable electronic device. The portable fuel cell is usually manufactured in the form of a polymer electrolyte membrane fuel cell or a direct liquid fuel cell stack.

The fuel cell stack is manufactured by coupling a plurality of unit cells for generating an electricity of about 0.5 V to 0.9 V in series to generate a desired voltage. The unit cell is called as a membrane electrode assembly. The fuel cell stack may be manufactured in a structure of alternately accumulating the unit cells and separators for distributing fuel to the unit cells and oxidant to a cathode. The stack structure is widely used because of its facile manufacturing process and excellent performance.

Meanwhile, if the contact force between the unit cells and the separators in the stack structure is weak, resistance increases at a boundary and a fluid may leak. On the contrary, the contact force between the unit cells and the separators is strong, durability of the unit cells or the separators may be reduced. Thus, in the fuel cell stack, accumulated bodies of the unit cells and the separators are required to be closely contacted with each other by proper pressure.

### SUMMARY OF THE INVENTION

Accordingly, it is an object of the present invention to provide a fuel cell stack in which a stack is rapidly and precisely assembled by the use of a bolting structure. It is another object of the present invention to provide a fuel cell stack having a proper coupling structure suitable for mass production.

The object of the present invention is not limited to the above mentioned objects, but other objects of the present invention will be apparently understood to those skilled in the art from the following description.

In order to achieve the foregoing and/or other objects of the present invention, according to one aspect of the present invention, there is provided a fuel cell stack including a first end plate, a second end plate facing the first end plate, a membrane electrode assembly stack disposed between the first and second end plates, a first separator disposed between the first end plate and the membrane electrode assembly stack, a second separator disposed between the second end plate and the membrane electrode assembly stack, and a coupling device penetrating the first end plate, the membrane electrode assembly stack, and the first and second separators. The second end plate has a coupling hole. The membrane electrode assembly stack includes at least one membrane electrode assembly for producing electricity. The coupling device is coupled to the coupling hole. The coupling device includes a head, a thread, and a body disposed between the head and the thread. An interface between the body and the thread has a step formed in a manner that a cross sectional area of the body is greater than a cross sectional area of the thread.

The body has a length to fix lengths of the membrane electrode assembly stack and the first and second separators to a predetermined length.

A cross-sectional area of the head of the coupling device is greater than that of the body.

The head of the coupling device may have an uneven step that contacts the first end plate.

The fuel cell stack further includes a release preventing device disposed between the head of the coupling device and the first end plate. The release preventing device includes a spring washer.

The fuel cell stack further includes an adhesive member disposed around the head of the coupling device to fix the head to the first end plate.

The fuel cell stack further includes an anchor for penetrating the second end plate to press and fix a side of the thread.

A length of the thread is less than a thickness of the second end plate, and a bottom of the coupling hole of the second end plate is closed.

The fuel cell stack further includes a fixing device coupled to an end of the thread extended beyond the second end plate, wherein a length of the thread is greater than a thickness of the second end plate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1A is an exploded view illustrating a fuel cell stack according to a first embodiment of the present invention;

FIG. 1B is a schematic view illustrating the main part of the fuel cell stack of FIG. 1A;

FIG. 2 is a schematic view illustrating a modification of the fuel cell stack according to an embodiment of the present invention;

FIG. 3 is a schematic view illustrating another modification of the fuel cell stack according to an embodiment of the present invention;

FIG. 4 is a front view illustrating a modification of a bolt employed in the fuel cell stack according to an embodiment of the present invention;

FIG. 5 is a partially exploded perspective view illustrating a bolt and a washer that are employed in the fuel cell stack according to an embodiment of the present invention;

FIG. 6 is a plan view illustrating an adhering device employed in the fuel cell according to an embodiment of the present invention; and

FIG. 7 is a schematic view illustrating an anchor employed in the fuel cell stack according to an embodiment of the present invention.

### DETAILED DESCRIPTION OF THE INVENTION

Hereinafter, certain exemplary embodiments according to the present invention will be described with reference to the accompanying drawings. Further, elements that are not essential to the complete understanding of the present invention are omitted for clarity. Also, like reference numerals refer to like elements throughout.

However, embodiments of the present invention may be modified into various forms and the scope of the present invention is not limited to the following description. The embodiments of the present invention are provided to those skilled in the art such that the present invention will be clearly and apparently understood. It is also noticed that like reference numerals refer to like elements throughout the drawings. Since thicknesses and sizes of respective layers are exaggerated for convenience clarity of illustration, actual thickness and sizes may be differed.

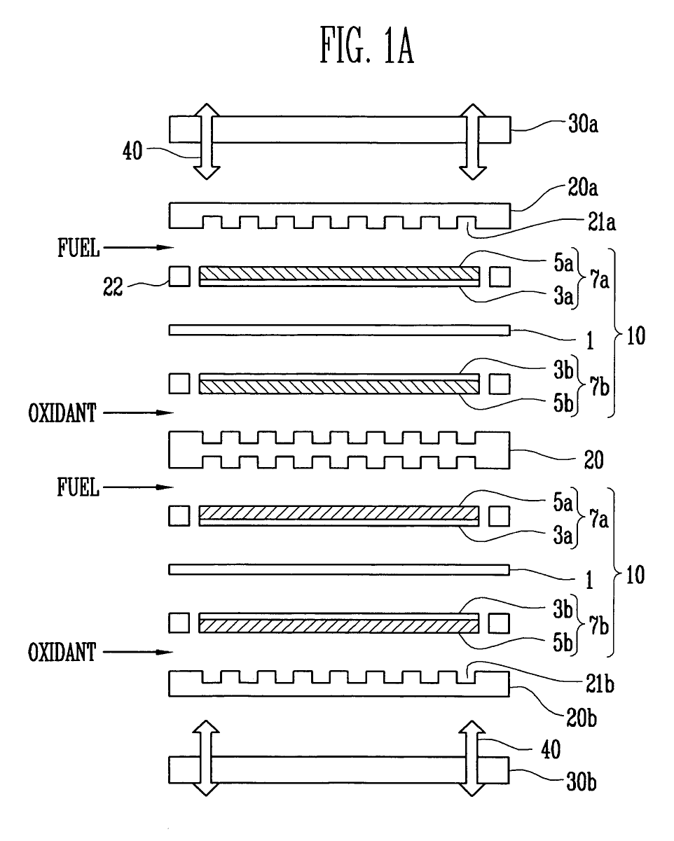

FIG. 1A is an exploded view illustrating a fuel cell stack according to a first embodiment of the present invention. Referring to FIG. 1A, the fuel cell stack includes a membrane electrode assembly 10, separators 20, 20a, and 20b, gaskets 22, a pair of end plates 30a and 30b, and a coupling device 40. In this embodiment, the coupling device 40 includes a bolting device, which is hereinafter referred to as a bolt 40.

The membrane electrode assembly 10 produces electricity through electrochemical reaction of fuel to be supplied to an anode with oxidant to be supplied to a cathode. A plurality of the membrane electrode assemblies 10 are electrically coupled with each other in series by separators. The fuel includes hydrocarbons fuel, such as butane, toluene, methane, ethane, or liquid or gaseous fuel with one of them as a chief component.

Moreover, the membrane electrode assembly 10 may include an electrolyte membrane 1, an anode catalyst layer 3a, a cathode catalyst layer 3b, an anode supporting layer 5a, and a cathode supporting layer 5b. In this description, the anode 7a includes the anode catalyst layer 3a and the anode supporting layer 5a, and the cathode 7b includes the cathode catalyst layer 3b and the cathode supporting layer 5b.

The electrolyte membrane 1 has an ion exchanging function of transferring hydrogen ions generated from the anode electrode 7a to the cathode electrode 7b. The electrolyte membrane 1 can be made of a polymer solid with a thickness of 50 micrometers to 200 micrometers, particularly a hydrogen ion conductive polymer. There are several conductive polymers such as fluorine polymer, ketone polymer, benzimidazole polymer, ester polymer, amide polymer, imide polymer, sulfone polymer, styrene polymer, and hydrocarbon polymer.

The anode catalyst layer 3a and the cathode catalyst layer 3b serve as a reaction accelerator such that fuel supplied from the outside can rapidly oxidize in a chemical reaction and oxygen introduced from the outside can rapidly deoxidize in a chemical reaction. The anode supporting layer 5a and the cathode supporting layer 5b support the catalyst layers 3a and 3b, and prevent the fuel, water, and air from being dispersed, generated electricity from being collected, and catalyst material from being lost.

The separator 20 is called as a bipolar plate or a separator plate. The separator 20 is disposed between the membrane electrode assemblies 10, forms fields of the fuel and the oxidizer that are supplied from the outside, and serves as a connector for electrically coupling adjacent membrane electrode assemblies 10 with each other. The separator 20 includes fuel flow fields 21a disposed on a side thereof and oxidant flow fields 21b disposed on the other side thereof. The separator 20 includes manifold openings (not shown) coupled with both ends of the fuel flow fields 21a and manifold openings (not shown) coupled with both ends of the oxidant flow fields 21b. The fuel flow fields 21a and the oxidant flow fields 21b have a serpentine shape but may be formed in another various employable forms and may have different shapes. The first and second separators 20a and 20b are disposed at the outermost sides of the stack. Each of the separators 20a and 20b includes a monopolar plate type separator having the fuel flow fields or the oxidant flow fields formed in a single side. Herein, the stack of the membrane electrode assemblies, and separators 20 formed between two of the membrane electrode assemblies is referred to as a membrane electrode assembly stack.

The separator 20 may be made of graphite, carbon, and metal coated with excellent anticorrosive materials, or excellent anticorrosive alloys. In a case of using stainless steel as a material for the separator 20, in order to improve conductivity, metal micro-particles penetrate the surface of the stainless steel and protrude from the surface.

The gaskets 22 are chiefly disposed between the membrane electrode assemblies 10 and the separator 20. The gaskets 20 prevent a fluid from leaking or foreign matter from being introduced between the fuel flow fields 21a or the oxidant flow fields 21b and the anode electrode 7a or the cathode electrode 7b. Materials with excellent elasticity and excellent maintenance of stress for heat cycle such as rubber, acryl, silicone, a thermoplastic elastomer, and metal are used as the gaskets 22.

The pair of end plates 30a and 30b press and support an accumulated body of the membrane electrode assemblies 10 and the separator 20 with a uniform pressure when coupling the stack. The pair of end plates 30a and 30b are disposed on the two separators 20a and 20b facing each other at both ends of the accumulated body. At least one of the two end plates 30a and 30b may have an introducing hole (not shown) and/or a discharge hole (not shown) for communicating a manifold with the outside. The end plates 30a and 30b are made of metal such as aluminum, an alloy such as stainless steel, a polymer composite material such as plastic, ceramic composite material, fiber reinforced polymer composite material.

The bolt 40 is a bolting device proposed in the present invention and has a structure for maintaining the length (or height) of the stack uniform when coupling the stack. The bolt 40 will be described with reference to FIG. 1B.

FIG. 1B is a schematic view illustrating the main part of the fuel cell stack of FIG. 1A. Referring to FIG. 1B, the accumulated body of the plurality of membrane electrode assemblies 10 and the plurality of separators 20 must closely contact under proper pressure when manufacturing the fuel cell stack. If not, desired performance and lifespan cannot be obtained from the manufactured fuel cell stack. Therefore, the accumulated body is coupled with the first and second end plates 30a and 30b by surrounding the accumulated body in the form of a sandwich with the first and second end plates 30a and 30b, and penetrating the bolt 40 through a fixing hole of the first end plate 30a.

The bolt 40 includes a head 42, a body 44, and a thread 46. The head 42 may have a hexagonal shape suitable for a wrench. The cross-sectional area of the head is greater than the cross-sectional area of the body 44, and the cross-sectional area of the body 44 is greater than that of the thread 46. Herein, the cross-sectional area is an area of a cross-section that is perpendicular to the penetrating direction of the bolt 40. In other words, a first step 43 is disposed at an interface between the head 42 and the body 44, and a second step 45 is disposed at an interface between the body 44 and the thread 46. When the second step 45 contacts the second end plate 30b, the bolt 40 is no more fastened.

Corresponding to the structure of the bolt 40, the fixing hole of the first end plate 30a includes a first hole 31, a second hole 33 with a smaller diameter than the first hole 31, and a step 32 disposed between the first and second holes 31 and 33. The fixing hole of the second end plate 30b has a coupling hole 35 formed with thread to be engaged with the thread 46 of the bolt 40.

The body 44 of the bolt 40 penetrates openings of the membrane electrode assemblies 10 and the opening of the separator 20. A length L1 of the body 44 is determined by a value obtained by experiments such that the membrane electrode assemblies 10 and the separator 20 closely contact each other by a predetermined force and a predetermined pressure formed therebetween when accumulating the same. By properly designing the length L1 of the body 44, the displacement or height of the stack can be fixed after the coupling of the stack and the stack can be precisely and rapidly coupled.

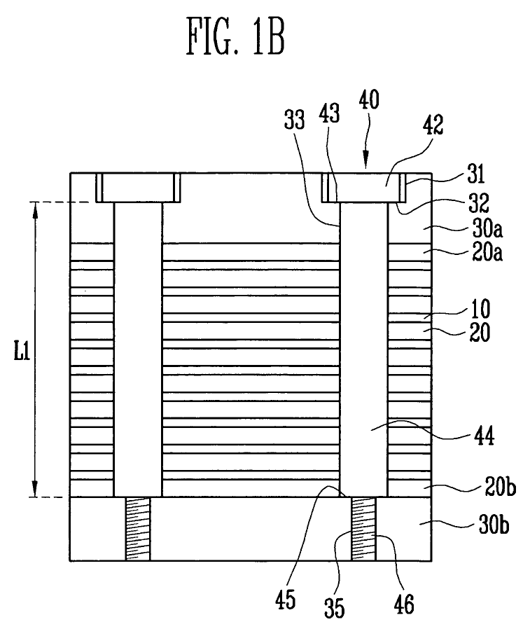

FIG. 2 is a schematic view illustrating a modification of the fuel cell stack according to an embodiment of the present invention.

Referring to FIG. 2, in the fuel cell stack according to this embodiment of the present invention, a bolt 40a includes a head 42, a body 44, and a thread 46a, and the length L2 of the thread 46a is less than the thickness L3 of a second end plate 30b′.

A coupling hole 35a of the second end plate 30b′ is formed with a depth corresponding to the length L2 of the thread 46a of the bolt 40a, and the end of the thread 46a is blocked to prevent the end from being exposed.

According to the above-mentioned structure, the bolt 40a inserted into the fixing hole of the first end plate 30a penetrates the accumulated body of the membrane electrode assemblies 10 and the separator 20 to be fastened with the second end plate 30b′. At this time, when the thread 46a of the bolt 40a is inserted into the coupling hole 35a of the second end plate 30b′ by a predetermined length L2, the bolt 40a is inserted no further by the second step 45 of the bolt 40a and the closed coupling hole 35a so that the stack can be fastened by a predetermined displacement.

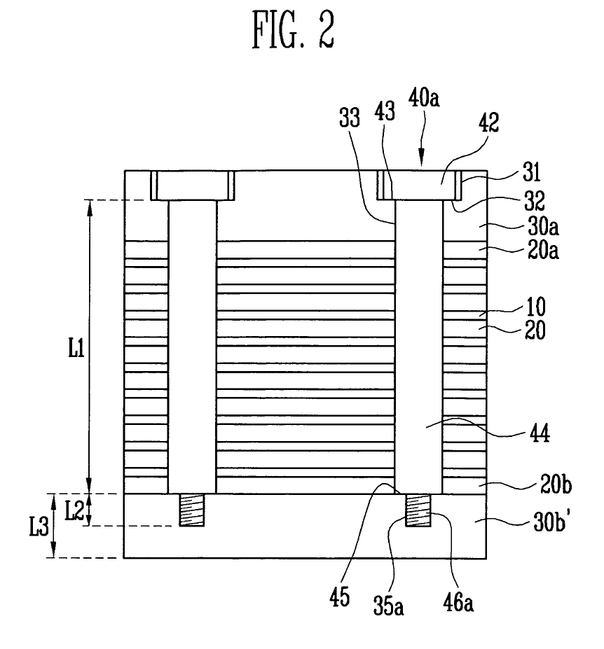

FIG. 3 is a schematic view illustrating another modification of the fuel cell stack according to an embodiment of the present invention. Referring to FIG. 3, in the fuel cell stack according to this embodiment of the present invention, a bolt 40b includes a head 42, a body 44, and a thread 46b.

The head 42 is not inserted into a first end plate 30a. In other words, a second hole 33a of the first end plate 30a′ corresponds to the size of the body 44 of the bolt 40b and has a diameter with a cross-sectional area less than the cross-sectional area of the head 42. Therefore, the head 42 of the bolt 40b is disposed to be fully exposed to the outer surface of the first end plate 30a′.

The length L1′ of the body 44 is increased as long as the head 42 is not inserted into the first end plate 30a′.

The length L4 of the thread 46b is longer than the thickness L3 of the second end plate 30b. Therefore, the bolt 40b penetrates the coupling hole 35 of the second end plate 30b, and the end of the thread 46b is exposed to the outside.

In this embodiment, the fuel cell stack includes a fixing device 50 coupled with an end of the thread 46b that is exposed to the outside. The fixing device 50 prevents the bolt 40b from being released after the coupling of the stack. A nut, a metal adhesive, and welding may be used as the fixing device 50. An alumina adhesive and a zirconia adhesive can be used as the metal adhesive. According to the above-mentioned structure, it is possible to prevent the bolt 40b from being released during the temperature cycle of the stack or for keeping in custody for a long time.

Examples of a bolt release preventing structure employed in the present invention will be described in detail as follows.

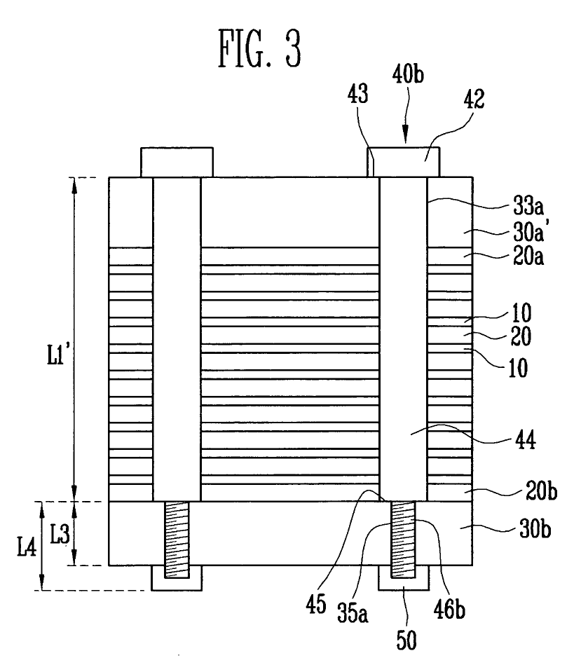

FIG. 4 is a front view illustrating a modification of a bolt employed in the fuel cell stack according to an embodiment of the present invention. Referring to FIG. 4, a bolt 40c according to this embodiment of the present invention includes a head 42a, a body 44, a thread 46, and an uneven step 48 formed at an interface between the head 42a and the body 44.

The uneven step 48 is preferably designed to have a shape for allowing easy rotation for the insertion of the bolt 40c and for preventing the bolt 40c from being released after the coupling of the stack. For example, the uneven step 48 may have a shape that rotates clockwise, and the surface of the head 42a gradually protrudes and is returned when viewing the head 42a from the thread 46. In other words, like the lower side of the head 42a of FIG. 4, the uneven step 48 may have a shape in which the thickness of the head 42a gradually increases and decreases.

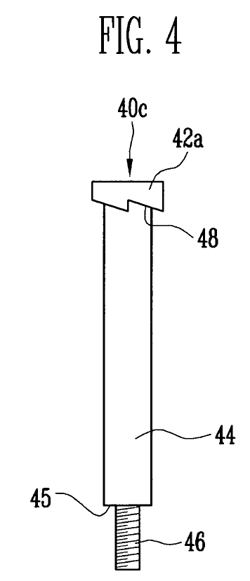

FIG. 5 is a partially exploded perspective view illustrating a bolt and a washer that are employed in the fuel cell stack according to an embodiment of the present invention. Referring to FIG. 5, a fuel cell stack according to this embodiment of the present invention includes an accumulated body of a plurality of membrane electrode assemblies 10 and a plurality of separators 20, a first end plate 30a disposed at an end of the accumulated body, a washer 47, and a bolt 40.

In the present embodiment, the fuel cell stack further includes the washer 47 disposed between the first end plate 30a and the head 42 of the bolt 40. The washer 47 includes a ring-shaped opening 47a formed at the center thereof. The washer 47 is inserted into the body 44 of the bolt 40 and is installed between the first end plate 30a and the head 42 of the bolt 40 in a state of being inserted into the body 44 of the bolt 40.

By using the washer 47, the bolt 40 can be prevented from being released when operating or stopping the stack, during the temperature cycle due to the change of ambient temperature, and in a case of keeping in custody for a long time after coupling the stack by the bolt 40. Therefore, the stack can be supported by the same pressure as that when initially coupling the stack so that reliability of the stack can be increased and lifespan can be guaranteed.

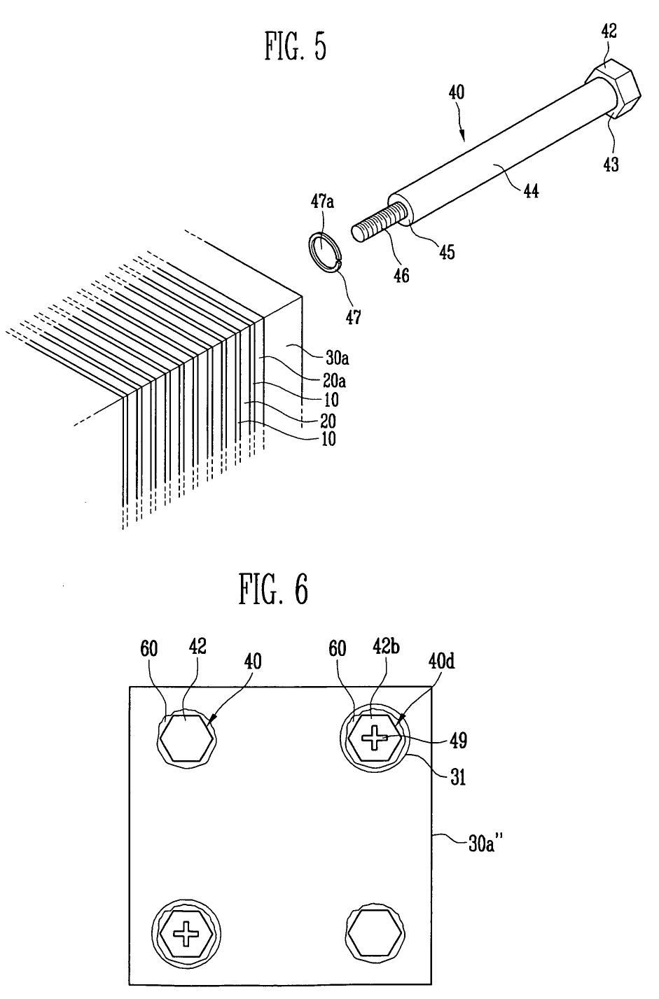

FIG. 6 is a plan view illustrating an adhering device employed in the fuel cell according to an embodiment of the present invention. Referring to FIG. 6, the fuel cell stack according to this embodiment of the present invention further includes an adhesive member 60 disposed around the head 42 of the bolt 40 coupled with a first end plate 30a″. The adhesive member 60 fixes the bolt 40 to the first end plate 30a″. The adhesive member 60 may be formed around the head 42 protruded from the first end plate 30a″ after fastening the bolt 40.

Moreover, the fuel cell stack according to this embodiment of the present invention further includes an adhesive member 60 disposed around a head 42b of another shaped bolt 40d coupled with a first end plate 30a″. The adhesive member 60 fixes the bolt 40d to a first hole 31 of the fixing hole and a step 32 of the first end plate 30a″. The adhesive member 60 may be formed around the head 42 in the fixing hole of the first end plate 30a″ after fastening the bolt 40d.

Corresponding to the two bolts 40 and 40d, the first end plate 30a″ may have a fixing hole indicated by a reference numeral 33a in FIG. 3 and fixing holes indicated by reference numerals 31, 32, and 33 in FIG. 2.

The adhesive member 60 may be implemented by a metal adhesive such as alumina adhesive and zirconia adhesive.

Meanwhile, the fuel cell stack of the present invention, as illustrated in FIG. 6, may employ a bolt 40d having a screw driver recess 49 formed in the head 42b in order to improve the coupling.

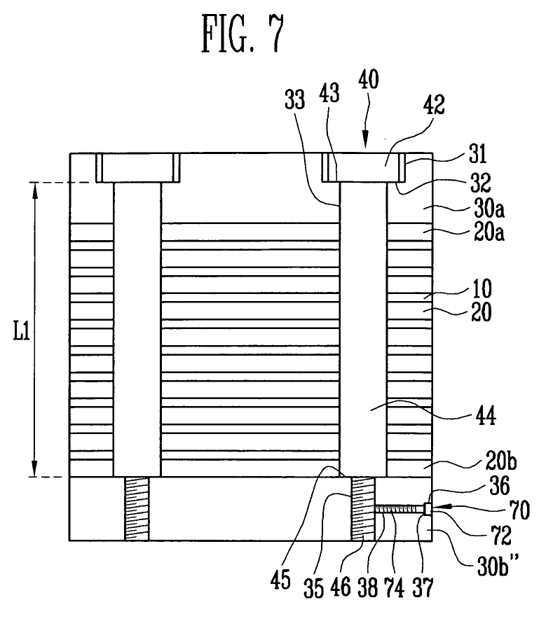

FIG. 7 is a schematic view illustrating an anchor employed in the fuel cell stack according to an embodiment of the present invention.

Referring to FIG. 7, the fuel cell stack of this embodiment of the present invention further includes an anchor 70 for fixing the bolt 40 to a second end plate 30b″. The anchor 70 includes a head 72 and a thread 74. The second end plate 30b″ further includes an anchor hole into which the anchor 70 is inserted. The anchor hole is formed in a direction substantially perpendicular to the fixing hole 35 into which the thread 46 of the bolt 40 is inserted. Corresponding to the structure of the anchor 70, the anchor hole includes a first hole 36 into which the head 72 of the anchor 70 is inserted and a second hole 38 communicated with the first hole 36 through a step 37 and having a diameter less than that of the first hole 36. The second hole 38 of the anchor hole communicates with the fixing hole 35.

According to the above-mentioned structure, the thread 46 of the bolt 40 is fastened into the fixing hole 35 of the second end plate 30b″ and after that, an end of the thread 74 of the anchor 70 presses a side of the thread 46 of the bolt 40. Therefore, the bolt 40 fastened to the fuel cell stack is prevented from being released by the anchor 70.

As such, the height of the stack is fixed by the length of the body of the fixing device so that the stack can be precisely and rapidly coupled by a predetermined height and productivity and efficiency can be improved in the mass production.

Although exemplary embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel cell stack comprising:
a first end plate;
a second end plate facing the first end plate, the second end plate having a coupling hole;
a membrane electrode assembly stack disposed between the first and second end plates, the membrane electrode assembly stack including at least one membrane electrode assembly for producing electricity;
a first separator disposed between the first end plate and the membrane electrode assembly stack;
a second separator disposed between the second end plate and the membrane electrode assembly stack; and
a coupling device penetrating the first end plate, the membrane electrode assembly stack, and the first and second separators, the coupling device being coupled to the coupling hole, the coupling device including:
a head;
a thread; and
a body disposed between the head and the thread, an interface between the body and the thread having a step formed in a manner that a cross-sectional area of the body is greater than a cross-sectional area of the thread.

2. The fuel cell stack as claimed in claim 1, wherein the body has a length to fix lengths of the membrane electrode assembly stack and the first and second separators to a predetermined length.

3. The fuel cell stack as claimed in claim 1, wherein a cross-sectional area of the head of the coupling device is greater than that of the body.

4. The fuel cell stack as claimed in claim 1, wherein the head of the coupling device has an uneven step that contacts the first end plate.

5. The fuel cell stack as claimed in claim 1, further comprising a release preventing device disposed between the head of the coupling device and the first end plate.

6. The fuel cell stack as claimed in claim 5, wherein the release preventing device comprises a spring washer.

7. The fuel cell stack as claimed in claim 1, further comprising an adhesive member disposed around the head of the coupling device to fix the head to the first end plate.

8. The fuel cell stack as claimed in claim 1, further comprising an anchor penetrating the second end plate to press and fix a side of the thread.

9. The fuel cell stack as claimed in claim 1, wherein a length of the thread is less than a thickness of the second end plate, and a bottom of the coupling hole of the second end plate is closed.

10. The fuel cell stack as claimed in claim 1, further comprising a fixing device coupled to an end of the thread extended beyond the second end plate, wherein a length of the thread is greater than a thickness of the second end plate.
